(19) United States
(12) Patent Application Publication
(10) Pub. No.: US 2006/0168546 A1
(43) Pub. Date: Jul. 27, 2006

(54) System and method for visualizing and navigating objectives

(75) Inventors: Scott M. Consolatti, Raleigh, NC (US); Tong L. Li, Cary, NC (US); Harold Moss III, Danvers, MA (US); Glen E. Salmon, Amesbury, MA (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/040,083

(22) Filed: Jan. 21, 2005

(51) Int. Cl. G06F 17/00; G06F 3/00

(52) U.S. Cl. 715/853; 715/764; 715/854

(57) ABSTRACT

A method, system, and computer program product for processing objectives of an organization. Included is a computerized system having: a graphical interface for displaying an objective hierarchy, wherein the objective hierarchy comprises a plurality of objectives; and a visual execution status system for displaying a visual execution status for each of the plurality of objectives, wherein the visual execution status connotes information regarding how well the objective is being performed.

### BACKGROUND OF THE INVENTION

1. Field of the Invention

The present invention relates generally to a computer implemented system for processing business objectives, and more specifically, the present invention provides a method, system, and computer program product for visualizing and navigating organizational wide objectives, and measuring an organization's performance at meeting those objectives.

2. Background Art

In order to track the success or failure of an organization, objectives are typically defined by the organization for some time period. For instance, an objective for a business might be $100 million in sales of a particular product for the upcoming year. Sales performance can then be compared to the objective to measure success or failure. Such objectives are defined based on goals required to implement a desired strategy for the organization.

Objectives are typically broken down into finer and finer detail down through the organization. For example, product sales for the aforementioned business may be organized by region, district, territory and individual salesperson. Thus, the business may have four regions, each having a sales objective of $25 million. One of those regions may have five districts, each with an objective of $5 million in sales. Each district in a given region may be responsible for $1 million, with territories having objectives of $200,000. Finally, individual sales people in the territories may have goals of $100,000 each.

Unfortunately, the impact of a lower level objective on one higher up in the organization is not automatically evident, and the impact is often detected too late to properly address the problem. Instead, each level in an organization typically evaluates its own progress and success based on external data and human effort. For instance, in the above example, a region will determine whether it is meeting its objectives by collecting and adding sales performance figures from each of its districts. If one of the districts is not meeting its objectives, additional human effort is typically required to determine which territory or territories are contributing to the failure, and which sales people within a given territory are failing to meet their objectives.

The ability to analyze objectives across an entire organization in an automated fashion would allow management at different levels to study and understand the performance of the organization. Unfortunately, there currently exists no automated mechanism that supports organization-wide objectives, the linking of objectives, and the impact or contribution a lower level objective has on a higher level objective.

### SUMMARY OF THE INVENTION

In general, the present invention provides a method, system, and computer program product that allows an organization's objectives and associated performances to be graphically displayed in a hierarchy. In a first aspect, the invention provides a computerized system for processing objectives, comprising: a graphical interface for displaying an objective hierarchy, wherein the objective hierarchy comprises a plurality of objectives; and a visual execution status system for displaying a visual execution status for each of the plurality of objectives, wherein the visual execution status connotes information regarding how well the objective is being performed.

In a second aspect, the invention provides a computer program product stored on a computer readable medium for processing objectives, comprising: program code configured for displaying an objective hierarchy, wherein the objective hierarchy comprises a plurality of objectives; and program code configured for displaying a visual execution status for each of the plurality of objectives, wherein the visual execution status connotes information regarding how well the objective is being performed.

In a third aspect, the invention provides a method for processing objectives, comprising: creating an objective hierarchy for an organization, wherein the objective hierarchy comprises a plurality of objectives; and graphically displaying the objective hierarchy along with a visual execution status for each of the plurality of objectives, wherein the visual execution status connotes information regarding how well the objective is being performed.

In a fourth aspect, the invention provides a method for deploying an application for processing objectives, comprising: providing a computer infrastructure being operable to: display an objective hierarchy, wherein the objective hierarchy comprises a plurality of objectives; and display a visual execution status for each of the plurality of objectives, wherein the visual execution status connotes information regarding how well the objective is being performed.

In a fifth aspect, the invention provides computer software embodied in a propagated signal for processing objectives, the computer software comprising instructions to cause a computer system to perform the following functions: display an objective hierarchy, wherein the objective hierarchy comprises a plurality of objectives; and display a visual execution status for each of the plurality of objectives, wherein the visual execution status connotes information regarding how well the objective is being performed.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computer system having an objective processing system in accordance with the present invention.

FIG. 2 depicts a graphical interface showing an objective hierarchy in accordance with the present invention.

FIG. 3 depicts a graphical interface showing a filtered objective hierarchy in accordance with the present invention.

FIG. 4 depicts a graphical interface showing an objective hierarchy in accordance with the present invention.

### DETAILED DESCRIPTION OF THE INVENTION

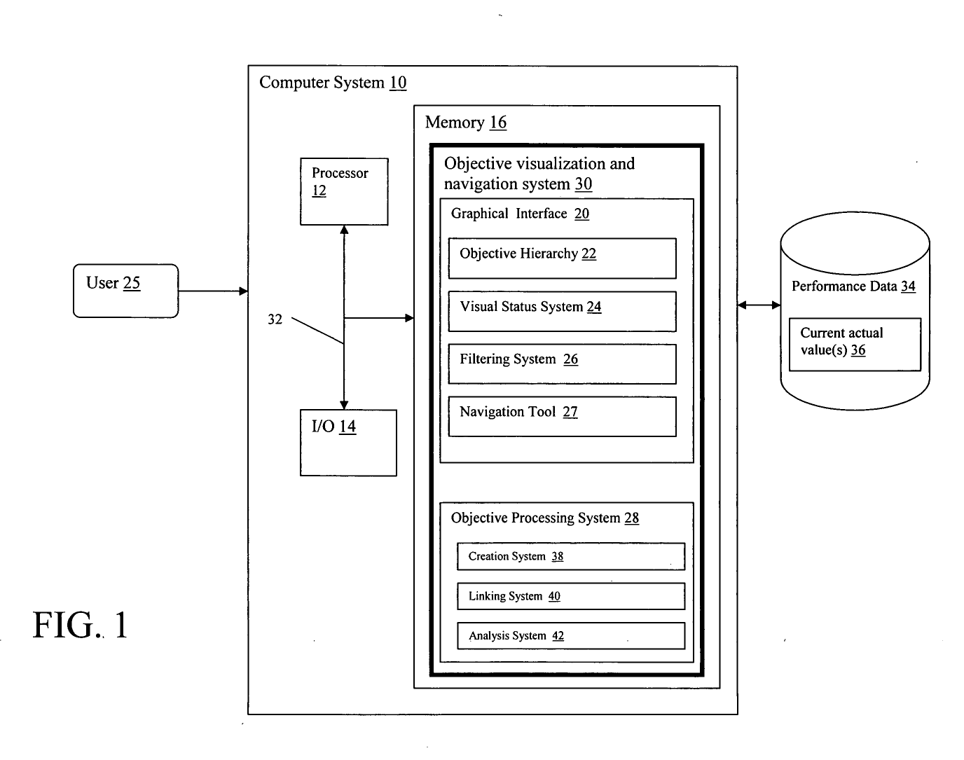

Referring now to the figures, FIG. 1 depicts a computer system 10 having an objective visualization and navigation system 30 for analyzing organization wide objectives. Computer system 10 is intended to represent any type of computerized system capable of implementing the methods and features of the present invention. For example, computer system 10 may comprise a desktop computer, laptop, workstation, server, PDA, cellular phone, pager, etc. As shown, computer system 10 generally includes a processor 12, memory 16, bus 32, and input/output interfaces (I/O) 14. Processor 12 may comprise a single processing unit, or may be distributed across one or more processing units in one or more locations, e.g., on a client and server. Memory 16 may comprise any known type of data storage and/or transmission media, including magnetic media, optical media, random access memory (RAM), read-only memory (ROM), etc. Moreover, similar to processor 12, memory 16 may reside at a single physical location, comprising one or more types of data storage, or be distributed across a plurality of physical systems in various forms.

I/O 14 may comprise any system for exchanging information to and from external devices/resources (not shown). External devices/resources may comprise any known type of external device, including: storage, a display, handheld device, keyboard, mouse, voice recognition system, speech output system, printer, facsimile, pager, speakers etc.

Bus 32 provides a communication link between each of the components in computer system 10, and likewise may comprise any known type of transmission link, including electrical, optical, wireless, etc. In addition, although not shown, additional components, such as cache memory, communication systems, system software, etc., may be incorporated into computer system 10.

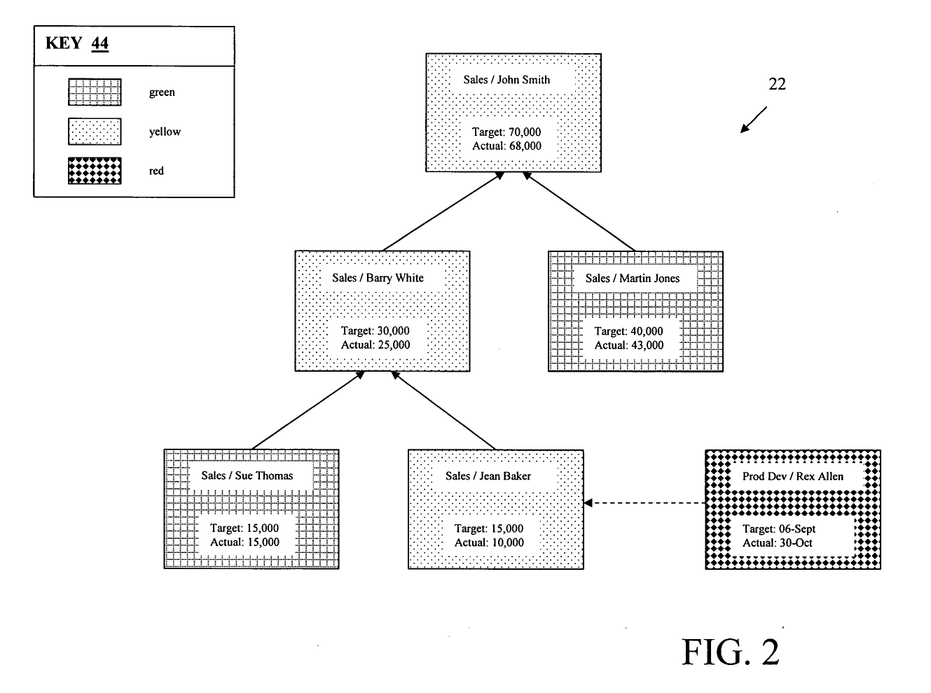

Shown in memory 16 is objective visualization and navigation system 30 that allows objectives to be created, viewed and analyzed by a user 25. Objectives are displayed in a graphical interface 20 as an objective hierarchy 22 as shown and described in FIGS. 2-4. Note that for the purposes of this invention, the term objective hierarchy may refer to any representation in which objectives are linked together (e.g., a tree, a directed graph, etc.). Graphical interface 20 also provides a visual status system 24 that uses, e.g., color-coding, iconic representations, etc., to graphically display a visual execution status of each objective being displayed. For instance, objectives that are being executed on schedule may be color-coded green, objectives that are being executed a little behind schedule may be color-coded yellow, and objectives that are being executed significantly behind schedule may be color-coded red.

Iconic representations may likewise be used to provide visual information when color is either insufficient or not available. Different icons may represent that an objective is executed on schedule, a little behind schedule, or significantly behind schedule. Additionally, the iconic representations may provide information related to change in performance over time. For instance, the iconic representations may indicate that the present performance is better than previous performance, present performance is unchanged from previous performance, or present performance is worse than previous performance. The use of color-coding and iconic representations may be configurable by the user 25 such that e.g., the user can select the colors, types of icons, etc.

In addition, graphical interface 20 may include a filtering system 26 that causes objectives to appear/not appear based on their execution status. Thus, for example, the user 25 is able to just view objectives that are in danger of not meeting their target.

An objective processing system 28 is also provided, which includes a creation system 38 for creating objectives, a linking system 40 for linking objectives together, and an analysis system 42 that reads in and assesses performance data 34 relative to targets or goals defined for the created objectives. Creation system 38 provides for the creation of objectives within an organization as a “top down” process, a “bottom up process,” or a mix of both. Each objective is created with a description (e.g., regional sales, units sold, # errors, etc.), a target for successful achievement over a span of time (e.g., $10 million in annual sales, 1000 defects over the next year, etc.), and measures for evaluating progress toward the target (e.g., daily, weekly or monthly goals, etc.). In a top down creation process, objectives are first entered at the top level of the organization (e.g., $100 million dollars in sales in the next year). The objectives, individually or in groups, are then “pushed” to subordinates who modify their versions of the objective's finer grain targets and measures (e.g., each of four divisions is responsible for $25 million in sales). This continues down to the individual contributors. At any level, a responsible user 25 may add, change or remove objectives within graphical interface 20.

Linking system 40 links the objectives together to indicate some dependency. Links may be quantitative or qualitative. Quantitative links define a numerical contribution one objective makes on another. For example, a higher level financial objective (i.e., destination objective) may have links from three other lower level financial objectives (i.e., source objectives), with the target or goal of the destination objective being the sum of the source objectives.

Any number of different contribution methods may be used to form a quantitative link, including additive, minimum, maximum, average, weighted average, etc. If additive is selected, the current actual values of all source objectives are added together and the result is assigned as the current actual value of for the destination objective. If minimum is selected, the smallest of the current actual values of all source objectives is selected as the current actual value of the destination objective. If maximum is selected, the largest of the current actual values of all source objectives is selected as the current actual value of the destination objective. If average is selected, the current actual values of each of the source objectives are averaged together and the result is assigned as the current actual value of the destination objective. If weighted average is selected, the current actual values of all source objectives are multiplied by their respective weighting, which are then added together and the result is assigned as the current actual value of the destination objective. It should be understood the contributions described herein are not an exhaustive list, and other contribution definitions may be used without departing from the scope of the invention.

Qualitative links show dependencies among objectives that cannot necessarily be numerically measured, but still have an impact. For instance, a sales objective may be dependent upon a product release date, adequate inventory, etc.

Analysis system 42 determines an execution status of an objective by comparing a current actual value 36 against a current target for the objective. The current actual value 36 represents performance data for the particular level of the organization to date, e.g., $80,000 in sales through the first three months of the year. The current target is a portion of the target set for the objective prorated to the current date. Thus, analysis system 42 calculates interim “current” targets anywhere along the span of time entered for the objective. Current targets can be calculated at any increments, e.g., quarterly, monthly, weekly, or even daily, using any prorating methodology (straight line, curve fitting, etc.). Based on the comparison of the current actual value 36 against the current target, analysis system 42 determines an execution status for the objective, which is utilized by visual status system 24 to display a visual execution status, e.g., green, yellow or red, depending on how close or far the current actual value 36 is from the current target. It should be understood that while the invention is described with three status levels implemented using color display types, any number of different status levels (e.g., low, medium low, medium, medium high, high, etc.) and/or display types (e.g., color, shape, size, texture, etc.) could be used without departing from the scope of the invention.

Referring now to FIG. 2, an illustrative objective hierarchy 22 is showing sales objectives at three levels in an organization. Note that any number of levels may be displayed in the graphical interface 20; however three generally provides a manageable number for the user 25. In this example, with the exception of Rex Allen, the linked objectives are implemented as quantitative contributions, and more specifically utilize additive contributions, i.e., the sums of the lower level “source” objectives equal a higher level “destination” objective.

Each objective is shown in a box that is color-coded to indicate a visual execution status (see Key 44). As can be seen, at the top level John Smith has a current target of $70,000 and a current actual value of $68,000. Because he is slightly behind his target, his box is color-coded yellow. Linked below John Smith at the second level is Barry White having a current target of $30,000 and a current actual value of $25,000, and Martin Jones having a current target of $40,000 and a current actual value of $43,000. As can be seen, Barry White, who is slightly behind target, is also color-coded yellow, while Martin Jones, who is ahead of target, is color-coded green. Note that the additive contributions of the respective current target and current actual values for Barry White and Martin Jones are equal to that of John Smith, i.e., 30,000+40,000=70,000 and 25,000+43,000=68,000.

Linked below Barry White at the third level is Sue Thomas having a current target of $15,000 and a current actual value of $15,000 (color-coded green) and Jean Baker having a current target of $15,000 and current actual value of $10,000 (color-coded yellow). Similar to that noted above, the additive contributions of the respective current target and current actual values for Sue Thomas and Jean Baker are equal to that of Barry White, 15,000+15,000=30,000 and 15,000+10,000=25,000.

Qualitatively linked to Jean Baker via dashed line 46 is Rex Allen, who is responsible for product development. As can be seen, Rex Allen is color-coded red since the delivery target date of 06-September was not met until 30-October. Thus, while a quantitative link is not possible between Rex Allen and Jean Baker, the qualitative link provides a visual explanation of why Jean Baker is in danger of not meeting her objective is provided. The resulting effects of this problem can be further traced up the objective hierarchy 22 through Barry White and finally John Smith. The affected path is immediately identifiable thanks to the color-coding provided by visual status system 24, in which the problem objectives are shown as either red or yellow. Thus, objective visualization and navigation system 30 allows for the visual analysis of objectives from an organizational wide perspective. Using this visual analysis, the causes and effects of problems failures among objectives can be readily identified.

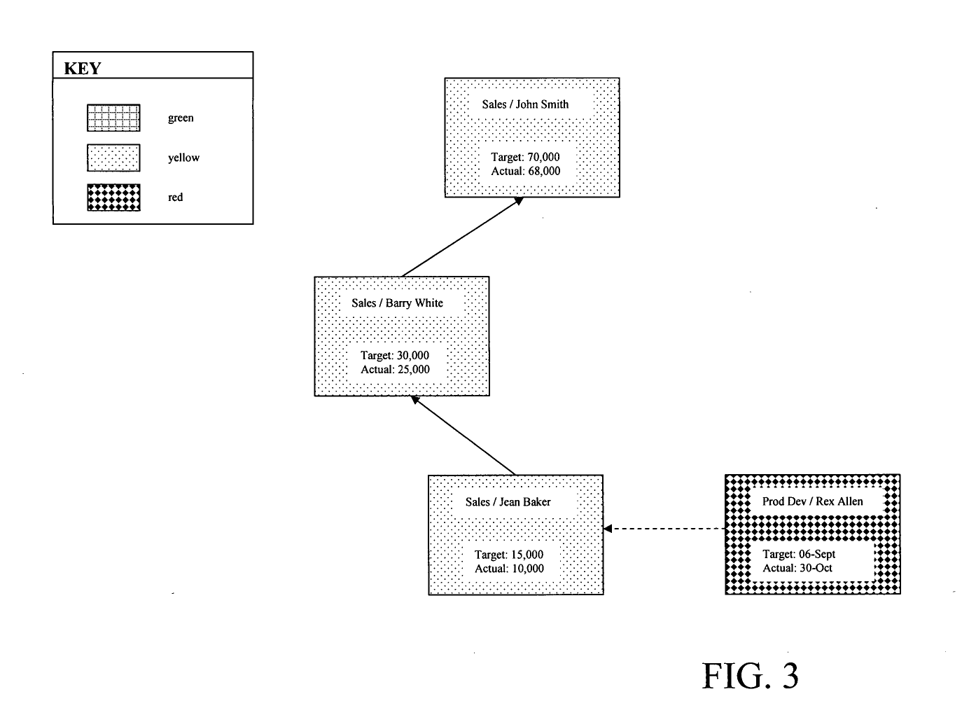

Referring now to FIG. 3, the objective hierarchy of FIG. 2 is shown with the filtering system 26 enacted to remove any “green” objectives from the graphical interface 20. Thus, only objectives with a status of yellow or red are shown. This feature allows the user 25 to quickly identify and analyze problem objectives in the organization. Filtering system 26 could be implemented in any manner relative to the visual execution status of objectives, e.g., only to show red objectives, only to show green objectives, do not show red objectives, etc.

As noted above, a navigation tool 27 is provided to facilitate navigation within the objective hierarchy 22. In large organizations, where there may be dozens of hierarchical levels, it may be desirable to traverse up and down the hierarchical tree while only displaying a few relevant levels. Accordingly, navigation tool 27 allows the user 25 to navigate up or down the objective hierarchy 22 to higher or lower levels such that a revised set of objectives are displayed. This could be implemented, e.g., by allowing the user to select a displayed objective, which would cause the graphical interface 20 to redisplay the graphical hierarchy 22 with the selected objective at the center.

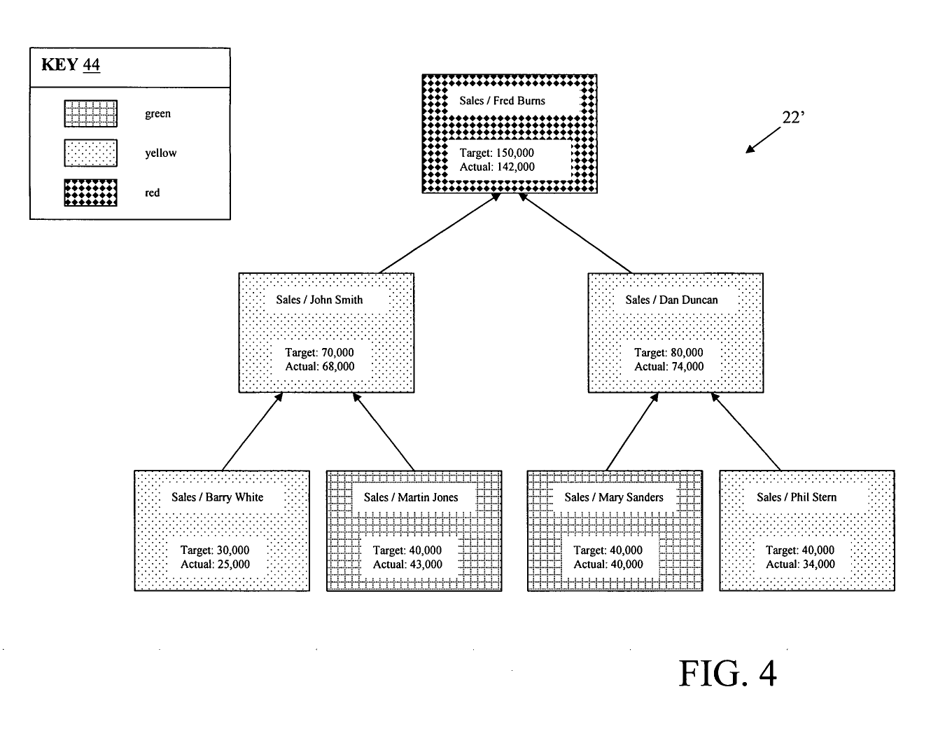

FIG. 4 shows a revised objective hierarchy 22′, which is the result of the navigation tool 27 navigating up one level from the objective hierarchy 22 shown in FIG. 2. As can be seen, John Smith, Barry White and Martin Jones have been moved down one level and a new top level, consisting of an objective for Fred Burns, now appears. Also appearing in FIG. 4 is a second set of objectives linked to Fred Burns consisting of Dan Duncan, Mary Sanders and Phil Stern. As can be seen in this example, Fred Burns has a visual execution status of red, indicating a danger of not meeting his target.

Obviously, the interfaces shown in FIG. 2-4 are provided for illustrative purposes only, and the specific presentation of data and format used therein could vary without departing from the scope of the invention.

It should be appreciated that the teachings of the present invention could be offered as a business method on a subscription or fee basis. For example, computer system 10 could be created, maintained, supported, and/or deployed by a service provider that offers the functions described herein for customers. That is, a service provider could be used to process organizational objectives over a network. It should also be understood that the present invention can be realized in hardware, software, a propagated signal, or any combination thereof. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A computerized system for processing objectives, comprising:
a graphical interface for displaying an objective hierarchy, wherein the objective hierarchy comprises a plurality of objectives; and
a visual execution status system for displaying a visual execution status for each of the plurality of objectives, wherein the visual execution status connotes information regarding how well the objective is being performed.

2. The computerized system of claim 1, wherein each objective has a defined target for a predetermined time span, and wherein each objective is displayed with:
a current target that is calculated by prorating the defined target of an objective for a selected point in time during the predetermined time span; and
a current actual value that comprises performance data at the selected point in time.

3. The computerized system of claim 2, wherein the visual execution status is determined by analyzing the current actual value for an objective relative to the current target for the objective.

4. The computerized system of claim 3, wherein the visual execution status is selected from the group consisting of: color-coding and iconic representation.

5. The computerized system of claim 3, further comprising a filtering system for selectively removing objectives from the objective hierarchy based the visual execution status determined for the objectives.

6. The computerized system of claim 1, further comprising a navigation system for graphically navigating the objective hierarchy.

7. The computerized system of claim 1, further comprising:
a system for creating objectives;
a system for linking objectives together; and
a system for analyzing objectives.

8. A computer program product stored on a computer readable medium for processing objectives, comprising:
program code configured for displaying an objective hierarchy, wherein the objective hierarchy comprises a plurality of objectives; and
program code configured for displaying a visual execution status for each of the plurality of objectives, wherein the visual execution status connotes information regarding how well the objective is being performed.

9. The computer program product of claim 8, wherein each objective has a defined target for a predetermined time span, and wherein each objective is displayed with:
a current target that is calculated by prorating the defined target of an objective for a selected point in time during the predetermined time span; and
a current actual value that comprises performance data at the selected point in time.

10. The computer program product of claim 9, wherein the visual execution status is determined by analyzing the current actual value for an objective relative to the current target for the objective.

11. The computer program product of claim 10, wherein the visual execution status is selected from the group consisting of: color-coding and iconic representation.

12. The computer program product of claim 10, further comprising program code configured for selectively removing objectives from the objective hierarchy based the visual execution status determined for the objectives.

13. The computer program product of claim 8, further comprising program code configured for graphically navigating the objective hierarchy.

14. The computer program product of claim 8, further comprising:
program code configured for creating objectives;
program code configured for linking objectives together; and
program code configured for analyzing objectives.

15. A method for processing objectives, comprising:
creating an objective hierarchy for an organization, wherein the objective hierarchy comprises a plurality of objectives; and
graphically displaying the objective hierarchy along with a visual execution status for each of the plurality of objectives, wherein the visual execution status connotes information regarding how well the objective is being performed.

16. The method of claim 15, wherein each objective has a defined target for a predetermined time span, and wherein each objective is displayed with:
a current target that is calculated by prorating the defined target of an objective for a selected point in time during the predetermined time span; and
a current actual value that comprises performance data at the selected point in time.

17. The method of claim 16, wherein the visual execution status is determined by analyzing the current actual value for an objective relative to the current target for the objective.

18. The method of claim 17, wherein the visual execution status is selected from the group consisting of: color-coding and iconic representation.

19. The method of claim 17, comprising the further step of selectively removing objectives from the objective hierarchy based the visual execution status determined for the objectives.

20. The method of claim 15, comprising the further step of graphically navigating the objective hierarchy.

21. The method of claim 15, wherein the creating step includes the step of linking objective together.

22. A method for deploying an application for processing objectives, comprising:
providing a computer infrastructure being operable to:
display an objective hierarchy, wherein the objective hierarchy comprises a plurality of objectives; and
display a visual execution status for each of the plurality of objectives, wherein the visual status connotes information regarding how well the objective is being performed.

23. Computer software embodied in a propagated signal for processing objectives, the computer software comprising instructions to cause a computer system to perform the following functions:
display an objective hierarchy, wherein the objective hierarchy comprises a plurality of objectives; and
display a visual execution status for each of the plurality of objectives, wherein the visual execution status connotes information regarding how well the objective is being performed.
